(19) United States
(12) Patent Application Publication
(10) Pub. No.: US 2011/0241613 A1
(43) Pub. Date: Oct. 6, 2011

(54) WIRELESS POWER RECEIVING APPARATUS INCLUDING A SHIELDING FILM

(75) Inventors: Young Ho Ryu, Yongin-si (KR); Eun Seok Park, Suwon-si (KR); Sang Wook Kwon, Seongnam-si (KR); Young Tack Hong, Seongnam-si (KR); Nam Yun Kim, Seoul (KR); Yun Kwon Park, Dongducheon-si (KR); Dong Zo Kim, Yongin-si (KR); Jin Sung Choi, Gimpo-si (KR)

(73) Assignee: Samsung Electronics Co., Ltd., Suwon-si (KR)

(21) Appl. No.: 13/053,592

(22) Filed: Mar. 22, 2011

(30) Foreign Application Priority Data
Mar. 31, 2010 (KR) 10-2010-0029548

(51) Int. Cl. H02J 7/00

(52) U.S. Cl. 320/108

(57) ABSTRACT

Provided is a battery pack that includes a resonator to receive power wirelessly. A film, for shielding from a magnetic field that may be generated due to an eddy current, may be inserted between a battery and the resonator of the battery pack.

### CROSS-REFERENCE TO RELATED APPLICATION(S)

This application claims the benefit under 35 U.S.C. §119(a) of Korean Patent Application No. 10-2010-0029548, filed on Mar. 31, 2010, in the Korean Intellectual Property Office, the entire disclosure of which is incorporated herein by reference for all purposes.

### BACKGROUND

1. Field

The following description relates to a wireless power receiving apparatus that has a resonator to receive power wirelessly.

2. Description of Related Art

Battery performance of portable electronic devices has become a critical issue. Besides portable electronic devices, home appliances may be provided with a function of wirelessly transmitting data. However, power is typically supplied to the home appliances and the portable electronic devices through a power line.

Among wireless power transmission technologies, a technology exists for wirelessly supplying power to a device or a battery of the device using a resonator. In a wireless power transmission technology, power may be supplied by inserting the resonator into the device. However, when the resonator is inserted into the device, an eddy current may be induced due to a conductor used for the battery of the device and the device. Due to the induced eddy current, an efficiency of the wireless power transmission may decrease and/or a malfunction may occur in the device or an element of the device.

### SUMMARY

In one general aspect, there is provided a wireless power receiving apparatus comprising a resonator to receive wireless power, a battery to charge a power source using the wireless power received by the resonator, and a film to shield against a magnetic field caused by an eddy current that occurs while the power source is charged.

The film may be disposed between the resonator and the battery, and a size of the film may be greater than a size of the battery.

The film may be disposed between the resonator and the battery to contact with a rear cover of a device, and a size of the film may be greater than a size of the battery.

The film may be disposed between the resonator and the battery to cover an entire area except for an area receiving the magnetic field of the resonator, and a size of the film may be greater than a size of the battery.

When a resonance frequency of the resonator is changed by the film, the changed resonance frequency may be corrected by adjusting at least one of a capacitance of a capacitor and an inductance of an inductor, of the resonator.

The resonator may be a three-dimensional (3D) type resonator that has thin film resonators disposed in parallel.

The wireless power receiving apparatus may further comprise a plurality of circuit boards that are configured to perform operations of a device, wherein the film is disposed between the resonator and the plurality of circuit boards.

In another aspect, there is provided a device comprising a resonator configured to receive power wirelessly from a source, a battery configured to charge a power source using the wireless power received by the resonator, a plurality of circuits boards configured to perform operations of the device, and a film configured to reduce the impact of an eddy current of the resonator on the battery and the plurality of circuit boards, wherein the film is disposed on a top surface of the resonator, and the battery and the plurality of circuit boards are disposed on a top surface of the film.

The device may further comprise a housing that houses the plurality of circuit boards and the battery.

The film may have a size that is greater than the size of battery and the plurality of circuit boards

When the resonance frequency of the resonator is changed due to the film, the resonator may be configured to be adjusted to correct the changed resonance frequency by adjusting at least one of a capacitance of a capacitor and an inductance of an inductor, of the resonator.

The resonator may comprise a plurality of thin film resonators disposed in parallel to each other, and each may be configured to receive power wirelessly from the source.

The film may be configured to reduce the impact of the eddy current which occurs when the battery is charging the power source, the plurality of circuit boards are in operation, and the resonator is receiving power wirelessly.

Other features and aspects will be apparent from the following detailed description, the drawings, and the claims.

### BRIEF DESCRIPTION OF THE DRAWINGS

FIG. 1 is a diagram illustrating an example of a wireless power transmission system.

FIG. 2 is a diagram illustrating an example of a battery pack including a resonator to transmit power wirelessly.

FIG. 3 is a diagram illustrating another example of a battery pack included in a device.

FIG. 4 is a diagram illustrating another example of a battery pack included in a device.

FIG. 5 through FIG. 11 are diagrams illustrating various examples of a resonator structure.

FIG. 12 is a diagram illustrating an example of an equivalent circuit of the resonator for wireless power transmission of FIG. 5.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, description of well-known functions and constructions may be omitted for increased clarity and conciseness.

A wireless power transmission technology is a technology for wirelessly transmitting energy from a power source to a device. A transmission distance may include not only a short range of several millimeters, but also a mid-range of a plurality of meters.

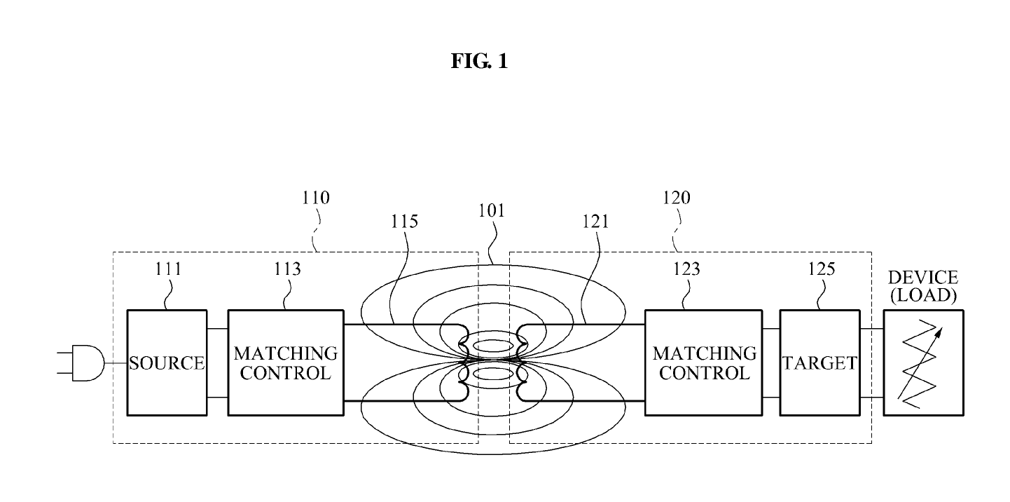

FIG. 1 illustrates an example of a wireless power transmission system.

In this example, power is transmitted wirelessly using the wireless power transmission system and may be referred to as resonance power.

Referring to FIG. 1, the wireless power transmission system may have a source-target structure that includes a source and a target. In this example, the wireless power transmission system includes a resonance power transmitter 110 corresponding to the source and a resonance power receiver 120 corresponding to the target.

The resonance power transmitter 110 includes a source unit 111 and a source resonator 115. The source unit 111 may receive energy from an external voltage supplier which may be used to generate resonance power. The resonance power transmitter 110 may further include a matching control 113 to perform resonance frequency or impedance matching.

For example, the source unit 111 may include an alternating current (AC)-to-AC (AC/AC) converter, an AC-to-direct current (DC) (AC/DC) converter, and a (DC/AC) inverter. The AC/AC converter may adjust a signal level of an AC signal input from an external device to a desired level. The AC/DC converter may output a DC voltage at a predetermined level by rectifying an AC signal output from the AC/AC converter. The DC/AC inverter may generate an AC signal, for example, a signal of a few megahertz (MHz) to tens of MHz band by quickly switching a DC voltage output from the AC/DC converter.

The matching control 113 may set at least one of a resonance bandwidth and an impedance matching frequency of the source resonator 115. Although not illustrated in figures, the matching control 113 may include at least one of a source resonance bandwidth setting unit and a source matching frequency setting unit. The source resonance bandwidth setting unit may set the resonance bandwidth of the source resonator 115. The source matching frequency setting unit may set the impedance matching frequency of the source resonator 115. In this example, a Q-factor of the source resonator 115 may be determined based on the setting of the resonance bandwidth of the source resonator 115 or the setting of the impedance matching frequency of the source resonator 115.

The source resonator 115 may transfer electromagnetic energy to a target resonator 121, as shown in FIG. 1. For example, the source resonator 115 may transfer resonance power to the resonance power receiver 120 through magnetic coupling 101 with the target resonator 121. The source resonator 115 may resonate within the set resonance bandwidth.

In this example, the resonance power receiver 120 includes the target resonator 121, a matching control 123 to perform resonance frequency or impedance matching, and a target unit 125 to transfer the received resonance power to a load.

The target resonator 121 may receive electromagnetic energy from the source resonator 115. The target resonator 121 may resonate within the set resonance bandwidth.

The matching control 123 may set at least one of a resonance bandwidth and an impedance matching frequency of the target resonator 121. Although not illustrated in figures, the matching control 123 may include at least one of a target resonance bandwidth setting unit and a target matching frequency setting unit. The target resonance bandwidth setting unit may set the resonance bandwidth of the target resonator 121. The target matching frequency setting unit may set the impedance matching frequency of the target resonator 121. In this example, a Q-factor of the target resonator 121 may be determined based on the setting of the resonance bandwidth of the target resonator 121 or the setting of the impedance matching frequency of the target resonator 121.

The target unit 125 may transfer the received resonance power to the load. For example, the target unit 125 may include an AC/DC converter and a DC/DC converter. The AC/DC converter may generate a DC voltage by rectifying an AC signal transmitted from the source resonator 115 to the target resonator 121. The DC/DC converter may supply a rated voltage to a device or the load by adjusting a voltage level of the DC voltage.

As an example, the source resonator 115 and the target resonator 121 may be configured in a helix coil structured resonator, a spiral coil structured resonator, a meta-structured resonator, and the like.

Referring to FIG. 1, a process of controlling the Q-factor may include setting the resonance bandwidth of the source resonator 115 and the resonance bandwidth of the target resonator 121, and transferring the electromagnetic energy from the source resonator 115 to the target resonator 121 through magnetic coupling 101 between the source resonator 115 and the target resonator 121. For example, the resonance bandwidth of the source resonator 115 may be set wider or narrower than the resonance bandwidth of the target resonator 121. For example, an unbalanced relationship between a BW-factor of the source resonator 115 and a BW-factor of the target resonator 121 may be maintained by setting the resonance bandwidth of the source resonator 115 to be wider or narrower than the resonance bandwidth of the target resonator 121.

In wireless power transmission employing a resonance scheme, the resonance bandwidth may be taken into consideration. For example, when the Q-factor considering a change in a distance between the source resonator 115 and the target resonator 121, a change in the resonance impedance, impedance mismatching, a reflected signal, and the like, is Qt, Qt may have an inverse-proportional relationship with the resonance bandwidth, as given by Equation 1.

$$\begin{matrix}\frac{Δ f}{{f}_{0}} = \frac{1}{Qt} \\ = {Γ}_{S , D} + \frac{1}{{BW}_{S}} + \frac{1}{{BW}_{D}}\end{matrix} \qquad [ Equation 1 ]$$

In Equation 1, f₀ corresponds to a central frequency, Δf corresponds to a change in a bandwidth, Γ_{S, D} corresponds to a reflection loss between the source resonator 115 and the target resonator 121, BWS corresponds to the resonance bandwidth of the source resonator 115, and BWD corresponds to the resonance bandwidth of the target resonator 121. For example, the BW-factor may indicate either 1/BWS or 1/BWD.

For example, a change in the distance between the source resonator 115 and the target resonator 121, a change in a location of at least one of the source resonator 115 and the target resonator 121, and the like, may cause impedance mismatching between the source resonator 115 and the target resonator 121. The impedance mismatching may be a direct cause in decreasing an efficiency of power transfer. When a reflected wave corresponding to a transmission signal that is partially reflected and returned is detected, the matching control 113 may determine that the impedance mismatching has occurred, and may perform impedance matching. For example, the matching control 113 may change a resonance frequency by detecting a resonance point through a waveform analysis of the reflected wave. The matching control 113 may determine, as the resonance frequency, a frequency that has a minimum amplitude in the waveform of the reflected wave. For example, to improve wireless power transfer, the matching control 113 may change the resonance frequency such that the reflected wave that is reflected in response to the resonance frequency, has a minimum amplitude.

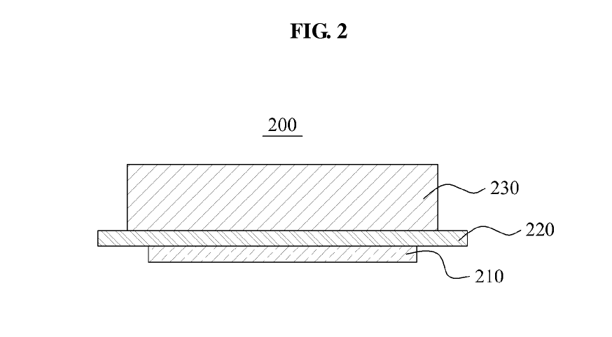

FIG. 2 illustrates an example of a battery pack including a resonator to transmit power wirelessly.

Referring to FIG. 2, battery pack 200 may be disposed inside of a device, and includes a resonator 210, a film 220, and a battery 230.

The resonator 210 may synchronize a resonance frequency for wireless power with a source resonator, and when the resonance frequency is synchronized with the source resonator, the resonator 210 may receive power wirelessly from a source. For example, the resonator 210 may provide the wireless power received from the source to the battery 230. As an example, a frequency equal to or less than 20 MHz may be used for the resonance frequency and a film having a high permeability and a low loss characteristic may be used.

For example, the resonator 210 operating as a target resonator may receive resonance power from the source resonator (not shown) using a resonance characteristic. When target resonator 210 and the source resonator resonate at the same frequency, energy may be transmitted based on a magnetic field through evanescent wave coupling. In this example, the energy may correspond to wireless power or resonance power.

While the battery 230 is charged with a power source, the film 220 may shield against a magnetic field that occurs due to an eddy current. To reduce a problem that occurs because of the eddy current, a film having a high permeability and a low loss characteristic may be used for the film 220.

When the resonance frequency of the resonator 210 changes because of the film 220, the changed resonance frequency may be corrected by adjusting at least one of a capacitance of a capacitor and an inductance of an inductor that are used for the resonator 210. For example, when the resonance frequency decreases, the resonance frequency may be corrected by decreasing the capacitance or the inductance. When a size of the resonator 210 is changed by an adjustment of the inductance, the capacitance may also be adjusted.

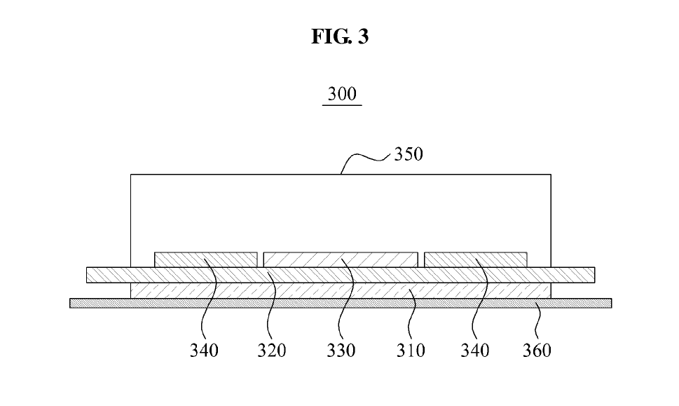

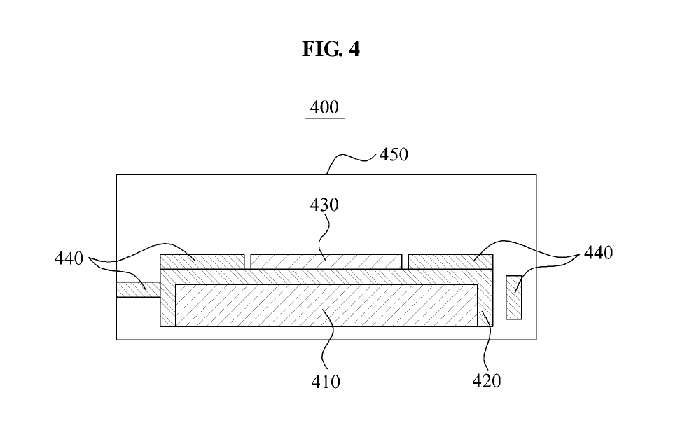

Accordingly, when the resonator 210 is inserted into a device, reduction in power transmission caused by the eddy current may be minimized. For example, the eddy current may be induced by a conductor used for the device including the battery pack 200 or the battery. A magnetic field may occur due to the eddy current. The magnetic field caused by the eddy current may offset a main magnetic field used for the power transmission. Accordingly, by minimizing the eddy current, the effect of the magnetic field may be reduced and/or minimized. Due to the eddy current, a redundant current may occur in the device, and the performance of an element of the device may deteriorate or degrade as a result of the eddy current. Accordingly, by minimizing the eddy current, the effect of the redundant current may be reduced and/or minimized. Such characteristic and effect may be applied to a battery pack of FIG. 3 and FIG. 4.

The battery pack 230 may receive power from the resonator 210 to generate energy for charging, and may charge a power source.

As illustrated in FIG. 2, the film 220 may be disposed between the resonator 210 and the battery 230. For example, the size of the film 220 may be greater than the size of the battery 230, so that a shielding efficiency may be increased. The film 220 may be disposed between the resonator 210 and the battery 230, and thus, an upper surface of the film 220 may be opposed to a lower surface of the battery 230. In this example, an area of the upper surface of the film 220 may be greater than an area of the lower surface of the battery 230. For example, the size or the area of the film 220 may be greater than the size or the area of the battery 230 by approximately 4 to 5%, by 5% or more, or any other desired size ratio.

FIG. 3 illustrates another example of a battery pack included in a device.

Referring to FIG. 3, a plurality of circuit boards 340 and the battery pack are disposed inside of device 300, and the plurality of circuit boards 340 and the battery pack are protected from an external impact by housing or main body 350. The plurality of circuit boards 340 may be used for performing an operation of the device 300, and may provide the same function or different functions.

The battery pack may be located between the plurality of circuit boards 340, and may be disposed to contact with a rear cover 360 of a device 300. In this example, the battery pack includes a resonator 310, a film 320, and a battery 330.

The resonator 310 may synchronize a resonance frequency for wireless power, and when the resonance frequency is synchronized, the resonator 310 may receive the wireless power from a source.

While the battery 330 is charged with a power source, the film 320 may shield against a magnetic field that is caused by an eddy current. To minimize a problem that occurs because of the eddy current, a film having a high permeability and a low loss characteristic may be used as the film 320.

When the resonance frequency of the resonator 310 is changed due to the film 320, the changed resonance frequency may be corrected by adjusting at least one of a capacitance of a capacitor and an inductance of an inductor used for the resonator 310.

The battery 330 may receive the power from the resonator 310 to generate energy for charging, and then may charge the power source.

As illustrated in FIG. 3, the film 320 may be disposed between the resonator 310 and the battery 330, and a size of the film 320 may be greater than a size of the battery 330, so that a shielding efficiency may be increased. The film 320 may be disposed between the resonator 310 and the battery 330, and thus, an upper surface of the film 320 may be opposed to a lower surface of the battery 330. In this example, an area of the lower surface of the film 320 may be greater than an area of the upper surface of the resonator 310. For example, the size or the area of the film 320 may be greater than the size or the area of the resonator 310 by approximately 4 to 5%, by 5% or more, or any other desired size ratio.

FIG. 4 illustrates another example of a battery pack included in a device.

Referring to FIG. 4, a plurality of circuit boards 440 and the battery pack are disposed inside of the device 400, and the plurality of circuit boards 440 and the battery pack are protected from an external impact by housing or main body 450. The plurality of circuit boards 440 may be used for performing operations of the device 400.

In this example, the battery pack is disposed inside of the device 400, and includes a resonator 410, a film 420, and a battery 430.

The resonator 410 may synchronize a resonance frequency for wireless power, and when the resonance frequency is synchronized, the resonator 410 may receive wireless power from a source.

While the battery 430 is charged with a power source, the film 420 may shield against a magnetic field that is caused by an eddy current. To minimize the effect of the eddy current, a film that has a high permeability and a low loss characteristic may be used for the film 420.

When the resonance frequency of the resonator 410 is changed due to the film 420, the changed resonance frequency may be corrected by adjusting at least one of a capacitance of a capacitor and an inductance of an inductor that are used for the resonator 410.

The battery 430 may receive the power from the resonator 410 to generate an energy for the charge, and then may charge the power source.

As illustrated in FIG. 4, when the resonator 410 is disposed inside of the device 400, film 420 may be disposed between the resonator 410 and the battery 430 to cover an entire area except for an area that receives the magnetic field of the resonator 410. The size of the film 420 may be greater than the size of the battery 430, to ensure that a shielding efficiency is maximized. For example, the size or the area of the film 420 may be greater than the size or the area of the resonator 410 by approximately 4 to 5%, by 5% or more, or any other desired size ratio.

At least one of the aforementioned resonators 210, 310, and 410 may be, for example, a 3D type resonator that has a plurality of thin film resonators that are disposed in parallel. When the plurality of thin film resonators are disposed in parallel, a transmission efficiency and transmission distance may be enhanced. As an example, a frequency equal to or less than 20 MHz may be used for the resonance frequency along with a film that has a high permeability and low loss characteristic.

A wireless power receiving apparatus including the resonator for receiving the wireless power may be inserted along with a shielding film between the resonator and the battery, and thus, decrease in power transmission efficiency caused by the eddy current may be reduced and/or minimized.

Because the wireless power receiving apparatus may shield a magnetic field due to the eddy current using the film, deterioration or degradation of the performance of the device due to the eddy current may be reduced and/or prevented.

For example, a source resonator and/or a target resonator may be configured as a helix coil structured resonator, a spiral coil structured resonator, a meta-structured resonator, and the like.

All materials may have a unique magnetic permeability (Mμ) and a unique permittivity, epsilon (ε). The magnetic permeability indicates a ratio between a magnetic flux density that occurs with respect to a given magnetic field in a corresponding material and a magnetic flux density that occurs with respect to the given magnetic field in a vacuum state. The magnetic permeability and the permittivity may determine a propagation constant of a corresponding material at a given frequency or at a given wavelength. An electromagnetic characteristic of the corresponding material may be determined based on the magnetic permeability and the permittivity.

For example, a material that has a magnetic permeability or a permittivity absent in nature and that is artificially designed is referred to as a metamaterial. The metamaterial may be easily disposed in a resonance state even in a relatively large wavelength area or a relatively low frequency area. For example, even though a material size rarely varies, the metamaterial may be easily disposed in the resonance state.

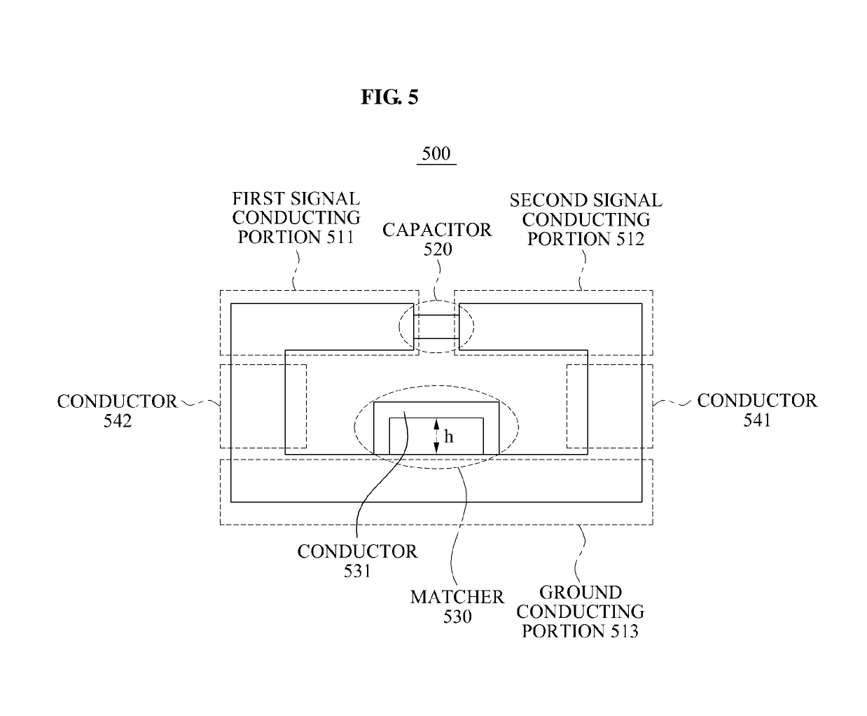

FIG. 5 illustrates a two-dimensional (2D) example of a resonator.

Referring to FIG. 5, resonator 500 includes a transmission line, a capacitor 520, a matcher 530, and conductors 541 and 542. In this example, the transmission line includes a first signal conducting portion 511, a second signal conducting portion 512, and a ground conducting portion 513.

The capacitor 520 may be inserted in series between the first signal conducting portion 511 and the second signal conducting portion 512, and an electric field may be confined within the capacitor 520. For example, the transmission line may include at least one conductor in an upper portion of the transmission line, and may also include at least one conductor in a lower portion of the transmission line. Current may flow through the at least one conductor disposed in the upper portion of the transmission line and the at least one conductor disposed in the lower portion of the transmission may be electrically grounded. In this example, a conductor disposed in an upper portion of the transmission line is referred to as the first signal conducting portion 511 and the second signal conducting portion 512. A conductor disposed in the lower portion of the transmission line is referred to as the ground conducting portion 513.

In this example, the transmission line includes the first signal conducting portion 511 and the second signal conducting portion 512 in the upper portion of the transmission line, and includes the ground conducting portion 513 in the lower portion of the transmission line. For example, the first signal conducting portion 511 and the second signal conducting portion 512 may be disposed such that they face the ground conducting portion 513. Current may flow through the first signal conducting portion 511 and the second signal conducting portion 512.

One end of the first signal conducting portion 511 may be shorted to the conductor 542, and another end of the first signal conducting portion 511 may be connected to the capacitor 520. One end of the second signal conducting portion 512 may be grounded to the conductor 541, and another end of the second signal conducting portion 512 may be connected to the capacitor 520. Accordingly, the first signal conducting portion 511, the second signal conducting portion 512, the ground conducting portion 513, and the conductors 541 and 542 may be connected to each other, such that the resonator 500 has an electrically closed-loop structure. The term “loop structure” may include a polygonal structure, for example, a circular structure, a rectangular structure, and the like. The loop structure indicates a circuit that is electrically closed.

The capacitor 520 may be inserted into an intermediate portion of the transmission line. For example, the capacitor 520 may be inserted into a space between the first signal conducting portion 511 and the second signal conducting portion 512. The capacitor 520 may have various shapes, for example, a shape of a lumped element, a distributed element, and the like. For example, a distributed capacitor that has the shape of the distributed element may include zigzagged conductor lines and a dielectric material that has a relatively high permittivity between the zigzagged conductor lines.

When the capacitor 520 is inserted into the transmission line, the resonator 500 may have a property of a metamaterial. The metamaterial indicates a material that has a predetermined electrical property that is absent in nature, and thus, may have an artificially designed structure. An electromagnetic characteristic of materials that exist in nature may have a unique magnetic permeability or a unique permittivity. Most materials may have a positive magnetic permeability or a positive permittivity. In the case of most materials, a right hand rule may be applied to an electric field, a magnetic field, and a pointing vector and thus, the corresponding materials may be referred to as right handed materials (RHMs).

However, a metamaterial has a magnetic permeability or a permittivity absent in nature, and thus, may be classified into, for example, an epsilon negative (ENG) material, a mu negative (MNG) material, a double negative (DNG) material, a negative refractive index (NRI) material, a left-handed (LH) material, and the like, based on a sign of the corresponding permittivity or magnetic permeability.

When a capacitance of the capacitor inserted as the lumped element is appropriately determined, the resonator 500 may have the characteristic of the metamaterial. Because the resonator 500 may have a negative magnetic permeability by adjusting the capacitance of the capacitor 520, the resonator 500 may also be referred to as an MNG resonator. Various criteria may be applied to determine the capacitance of the capacitor 520. For example, the various criteria may include a criterion for enabling the resonator 500 to have the characteristic of the metamaterial, a criterion for enabling the resonator 500 to have a negative magnetic permeability in a target frequency, a criterion for enabling the resonator 500 to have a zeroth order resonance characteristic in the target frequency, and the like. The capacitance of the capacitor 520 may be determined based on at least one criterion.

The resonator 500, also referred to as the MNG resonator 500, may have a zeroth order resonance characteristic that has, as a resonance frequency, a frequency when a propagation constant is “0”. For example, a zeroth order resonance characteristic may be a frequency transmitted through a line or a medium that has a propagation constant of “0.” Because the resonator 500 may have the zeroth order resonance characteristic, the resonance frequency may be independent with respect to a physical size of the MNG resonator 500. By appropriately designing the capacitor 520, the MNG resonator 500 may sufficiently change the resonance frequency. Accordingly, the physical size of the MNG resonator 500 may not be changed.

In a near field, the electric field may be concentrated on the capacitor 520 inserted into the transmission line. Accordingly, due to the capacitor 520, the magnetic field may become dominant in the near field. The MNG resonator 500 may have a relatively high Q-factor using the capacitor 520 of the lumped element and thus, it is possible to enhance an efficiency of power transmission. In this example, the Q-factor indicates a level of an ohmic loss or a ratio of a reactance with respect to a resistance in the wireless power transmission. It should be understood that the efficiency of the wireless power transmission may increase according to an increase in the Q-factor.

The MNG resonator 500 may include the matcher 530 for impedance matching. The matcher 530 may adjust the strength of a magnetic field of the MNG resonator 500. An impedance of the MNG resonator 500 may be determined by the matcher 530. For example, current may flow into and/or out of the MNG resonator 500 via a connector. The connector may be connected to the ground conducting portion 513 or the matcher 530. Power may be transferred through coupling without using a physical connection between the connector and the ground conducting portion 513 or the matcher 530.

For example, as shown in FIG. 5, the matcher 530 may be positioned within the loop formed by the loop structure of the resonator 500. The matcher 530 may adjust the impedance of the resonator 500 by changing the physical shape of the matcher 530. For example, the matcher 530 may include the conductor 531 for the impedance matching in a location that is separated from the ground conducting portion 513 by a distance h. Accordingly, the impedance of the resonator 500 may be changed by adjusting the distance h.

Although not illustrated in FIG. 5, a controller may be provided to control the matcher 530. In this example, the matcher 530 may change the physical shape of the matcher 530 based on a control signal generated by the controller. For example, the distance h between the conductor 531 of the matcher 530 and the ground conducting portion 513 may increase or decrease based on the control signal. Accordingly, the physical shape of the matcher 530 may be changed and the impedance of the resonator 500 may be adjusted. The controller may generate the control signal based on various factors, which are further described later.

As shown in FIG. 5, the matcher 530 may be configured as a passive element such as the conductor 531. As another example, the matcher 530 may be configured as an active element such as a diode, a transistor, and the like. When the active element is included in the matcher 530, the active element may be driven based on the control signal generated by the controller, and the impedance of the resonator 500 may be adjusted based on the control signal. For example, a diode that is a type of active element may be included in the matcher 530. The impedance of the resonator 500 may be adjusted depending on whether the diode is in an ON state or in an OFF state.

Although not illustrated in FIG. 5, a magnetic core may pass through the MNG resonator 500. The magnetic core may increase a power transmission distance.

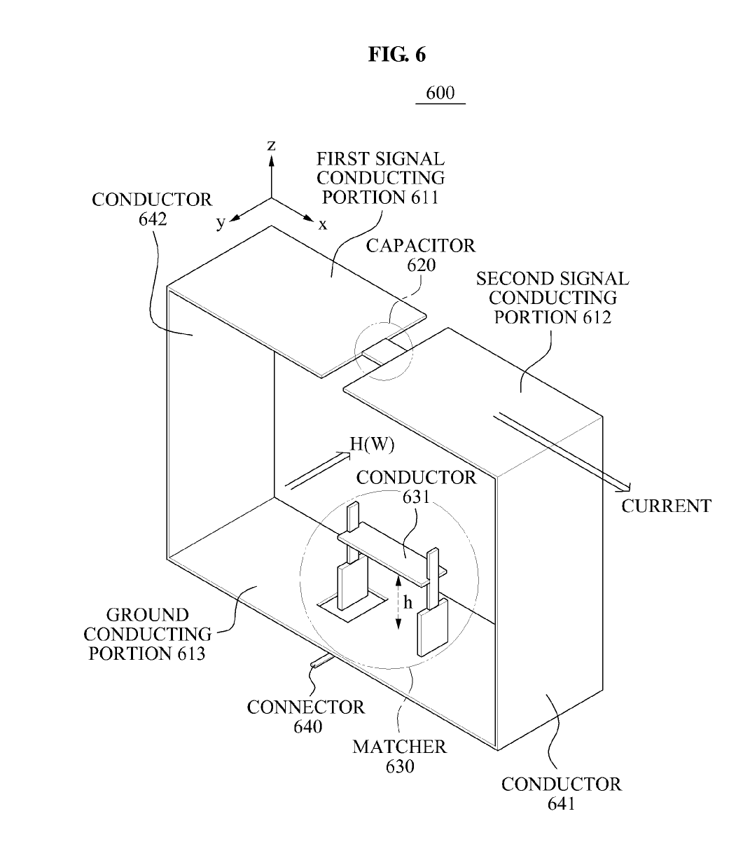

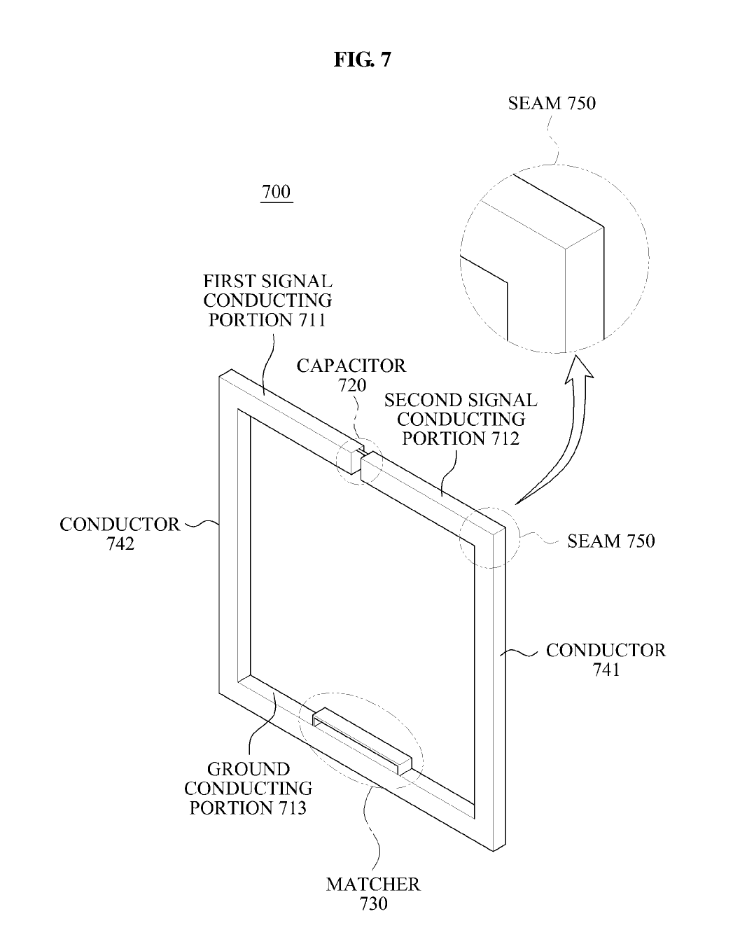

FIG. 6 illustrates a three-dimensional (3D) example of a resonator.

Referring to FIG. 6, resonator 600 includes a transmission line and a capacitor 620. In this example, the transmission line includes a first signal conducting portion 611, a second signal conducting portion 612, and a ground conducting portion 613. The capacitor 620 may be inserted in series between the first signal conducting portion 611 and the second signal conducting portion 612 of the transmission line, and an electric field may be confined within the capacitor 620.

In this example, the transmission line includes the first signal conducting portion 611 and the second signal conducting portion 612 in an upper portion of the resonator 600, and includes the ground conducting portion 613 in a lower portion of the resonator 600. For example, the first signal conducting portion 611 and the second signal conducting portion 612 may be disposed such that they face the ground conducting portion 613. Current may flow in an x direction through the first signal conducting portion 611 and the second signal conducting portion 612. As a result of the current, a magnetic field H(W) may be formed in a −y direction. Alternatively, unlike the diagram of FIG. 6, the magnetic field H(W) may be formed in a +y direction.

One end of the first signal conducting portion 611 may be shorted to the conductor 642, and another end of the first signal conducting portion 611 may be connected to the capacitor 620. One end of the second signal conducting portion 612 may be grounded to the conductor 641, and another end of the second signal conducting portion 612 may be connected to the capacitor 620. Accordingly, the first signal conducting portion 611, the second signal conducting portion 612, the ground conducting portion 613, and the conductors 641 and 642 may be connected to each other, such that the resonator 600 has an electrically closed-loop structure, as described with reference to FIG. 5.

As shown in FIG. 6, the capacitor 620 may be inserted between the first signal conducting portion 611 and the second signal conducting portion 612. For example, the capacitor 620 may be inserted into a space between the first signal conducting portion 611 and the second signal conducting portion 612. The capacitor 620 may have various shapes, for example, a shape of a lumped element, a distributed element, and the like. For example, a distributed capacitor that has the shape of the distributed element may include zigzagged conductor lines and a dielectric material that has a relatively high permittivity between the zigzagged conductor lines.

As the capacitor 620 is inserted into the transmission line, the resonator 600 may have a property of a metamaterial.

When a capacitance of the capacitor inserted as the lumped element is appropriately determined, the resonator 600 may have the characteristic of the metamaterial. Because the resonator 600 may have a negative magnetic permeability by adjusting the capacitance of the capacitor 620, the resonator 600 may also be referred to as an MNG resonator. Various criteria may be applied to determine the capacitance of the capacitor 620. For example, the various criteria may include a criterion for enabling the resonator 600 to have the characteristic of the metamaterial, a criterion for enabling the resonator 600 to have a negative magnetic permeability in a target frequency, a criterion enabling the resonator 600 to have a zeroth order resonance characteristic in the target frequency, and the like. The capacitance of the capacitor 620 may be determined based on at least one criterion.

The resonator 600, also referred to as the MNG resonator 600, may have a zeroth order resonance characteristic that has, as a resonance frequency, a frequency when a propagation constant is “0”. Because the resonator 600 may have the zeroth order resonance characteristic, the resonance frequency may be independent with respect to a physical size of the MNG resonator 600. By appropriately designing the capacitor 620, the MNG resonator 600 may sufficiently change the resonance frequency. Accordingly, the physical size of the MNG resonator 600 may not be changed.

Referring to the MNG resonator 600 of FIG. 6, in a near field, the electric field may be concentrated on the capacitor 620 inserted into the transmission line. Accordingly, due to the capacitor 620, the magnetic field may become dominant in the near field. For example, because the MNG resonator 600 having the zeroth-order resonance characteristic may have characteristics similar to a magnetic dipole, the magnetic field may become dominant in the near field. A relatively small amount of the electric field formed due to the insertion of the capacitor 620 may be concentrated on the capacitor 620 and thus, the magnetic field may become further dominant.

Also, the MNG resonator 600 may include the matcher 630 for impedance matching. The matcher 630 may adjust the strength of magnetic field of the MNG resonator 600. An impedance of the MNG resonator 600 may be determined by the matcher 630. For example, current may flow into and/or out of the MNG resonator 600 via a connector 640. The connector 640 may be connected to the ground conducting portion 613 or the matcher 630.

For example, as shown in FIG. 6, the matcher 630 may be positioned within the loop formed by the loop structure of the resonator 600. The matcher 630 may adjust the impedance of the resonator 600 by changing the physical shape of the matcher 630. For example, the matcher 630 may include the conductor 631 for the impedance matching in a location that is separated from the ground conducting portion 613 by a distance h. Accordingly, the impedance of the resonator 600 may be changed by adjusting the distance h.

Although not illustrated in FIG. 6, a controller may be provided to control the matcher 630. In this example, the matcher 630 may change the physical shape of the matcher 630 based on a control signal generated by the controller. For example, the distance h between the conductor 631 of the matcher 630 and the ground conducting portion 613 may increase or decrease based on the control signal. Accordingly, the physical shape of the matcher 630 may be changed and the impedance of the resonator 600 may be adjusted.

The distance h between the conductor 631 of the matcher 630 and the ground conducting portion 631 may be adjusted using a variety of schemes. For example, a plurality of conductors may be included in the matcher 630 and the distance h may be adjusted by adaptively activating one of the conductors. As another example, the distance h may be adjusted by adjusting the physical location of the conductor 631 up and down. The distance h may be controlled based on the control signal of the controller. For example, the controller may generate the control signal using various factors. An example of the controller generating the control signal is further described later.

As shown in FIG. 6, the matcher 630 may be configured as a passive element such as the conductor 631. As another example, the matcher 630 may be configured as an active element such as a diode, a transistor, and the like. When the active element is included in the matcher 630, the active element may be driven based on the control signal generated by the controller, and the impedance of the resonator 600 may be adjusted based on the control signal. For example, a diode that is a type of the active element may be included in the matcher 630. The impedance of the resonator 600 may be adjusted depending on whether the diode is in an ON state or in an OFF state.

Although not illustrated in FIG. 6, a magnetic core may pass through the resonator 600 configured as the MNG resonator. The magnetic core may increase a power transmission distance.

FIG. 7 illustrates an example of a bulky-type resonator for wireless power transmission.

Referring to FIG. 7, a first signal conducting portion 711 and a second signal conducting portion 712 may be integrally formed instead of being separately manufactured and later connected to each other. Similarly, the second signal conducting portion 712 and the conductor 741 may also be integrally manufactured.

When the second signal conducting portion 712 and the conductor 741 are separately manufactured and connected to each other, a loss of conduction may occur due to a seam 750. The second signal conducting portion 712 and the conductor 741 may be connected to each other without using a separate seam such that they are seamlessly connected to each other. Accordingly, it is possible to decrease a conductor loss caused by the seam 750. Accordingly, the second signal conducting portion 712 and the ground conducting portion 731 may be seamlessly and integrally manufactured. Similarly, the first signal conducting portion 711 and the ground conducting portion 731 may be seamlessly and integrally manufactured.

Referring to FIG. 7, a type of a seamless connection connecting at least two partitions into an integrated form is referred to as a bulky type.

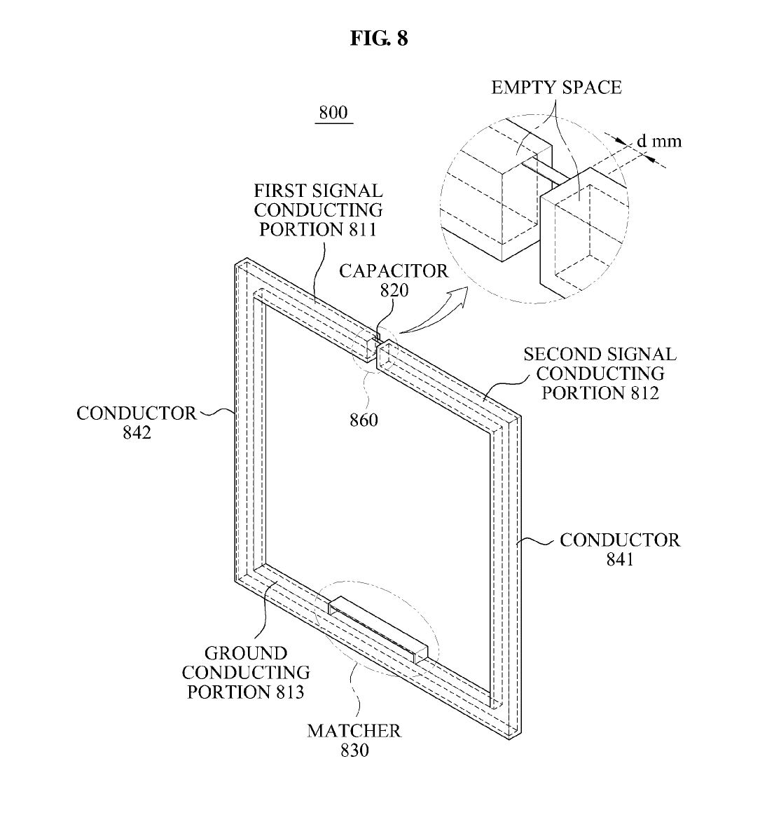

FIG. 8 illustrates an example of a hollow-type resonator for wireless power transmission.

Referring to FIG. 8, each of a first signal conducting portion 811, a second signal conducting portion 812, a ground conducting portion 813, and conductors 841 and 842 of the resonator 800 configured as the hollow-type include an empty space inside.

In a given resonance frequency, an active current may be modeled to flow in only a portion of the first signal conducting portion 811 instead of the entire first signal conducting portion 811, only a portion of the second signal conducting portion 812 instead of the entire second signal conducting portion 812, only a portion of the ground conducting portion 813 instead of the entire ground conducting portion 813, and only a portion of the conductors 841 and 842 instead of the entire conductors 841 and 842. For example, when a depth of each of the first signal conducting portion 811, the second signal conducting portion 812, the ground conducting portion 813, and the conductors 841 and 842 is significantly deeper than a corresponding skin depth in the given resonance frequency, it may be ineffective. The significantly deeper depth may increase a weight or manufacturing costs of the resonator 800.

Accordingly, in the given resonance frequency, the depth of each of the first signal conducting portion 811, the second signal conducting portion 812, the ground conducting portion 813, and the conductors 841 and 842 may be appropriately determined based on the corresponding skin depth of each of the first signal conducting portion 811, the second signal conducting portion 812, the ground conducting portion 813, and the conductors 841 and 842. When the first signal conducting portion 811, the second signal conducting portion 812, the ground conducting portion 813, and the conductors 841 and 842 have an appropriate depth that is deeper than a corresponding skin depth, the resonator 800 may become light, and manufacturing costs of the resonator 800 may also decrease.

For example, as shown in FIG. 8, the depth of the second signal conducting portion 812 may be determined as “d” mm and d may be determined according to

$$d = \frac{1}{\sqrt{π f μ σ}} .$$

In this example, f corresponds to a frequency, μ corresponds to a magnetic permeability, and σ corresponds to a conductor constant.

For example, when the first signal conducting portion 811, the second signal conducting portion 812, the ground conducting portion 813, and the conductors 841 and 842 are made of a copper and have a conductivity of 5.8×107 siemens per meter (S·m−1), the skin depth may be about 0.6 mm with respect to 10 kHz of the resonance frequency and the skin depth may be about 0.006 mm with respect to 100 MHz of the resonance frequency.

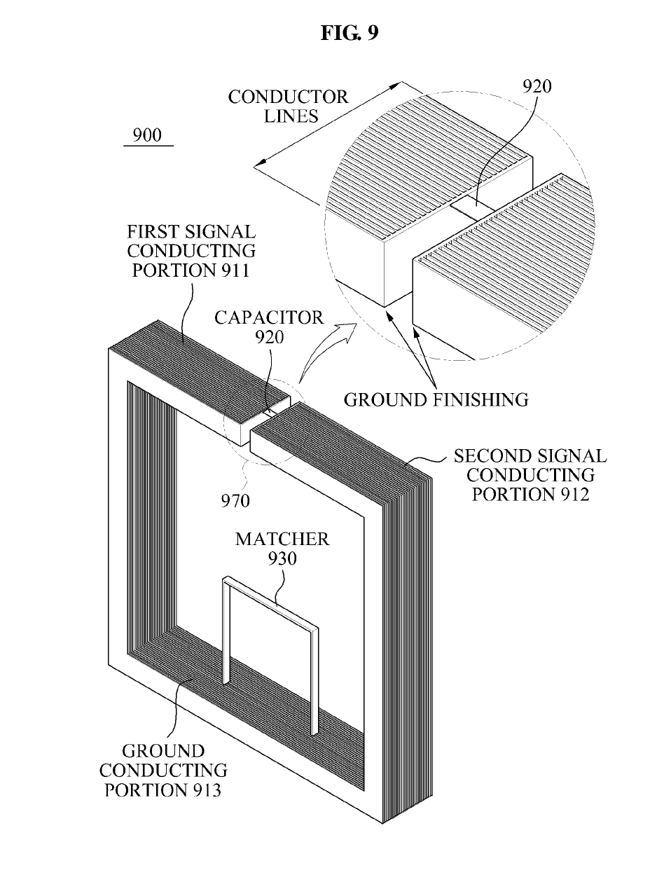

FIG. 9 illustrates an example of a resonator for wireless power transmission using a parallel-sheet.

Referring to FIG. 9, the parallel-sheet may be applicable to each of a first signal conducting portion 911 and a second signal conducting portion 912 included in the resonator 900.

For example, the first signal conducting portion 911 and the second signal conducting portion 912 may not be a perfect conductor, and thus, may have a resistance. Due to the resistance, an ohmic loss may occur. The ohmic loss may decrease a Q-factor and may also decrease a coupling effect.

By applying the parallel-sheet to each of the first signal conducting portion 911 and the second signal conducting portion 912, it is possible to decrease the ohmic loss, and to increase the Q-factor and the coupling effect. For example, referring to a portion 970 indicated by a circle, when the parallel-sheet is applied, each of the first signal conducting portion 911 and the second signal conducting portion 912 may include a plurality of conductor lines. For example, the plurality of conductor lines may be disposed in parallel, and may be shorted at an end portion of each of the first signal conducting portion 911 and the second signal conducting portion 912.

As described above, when the parallel-sheet is applied to each of the first signal conducting portion 911 and the second signal conducting portion 912, the plurality of conductor lines may be disposed in parallel. Accordingly, a sum of resistances having the conductor lines may decrease. As a result, the resistance loss may decrease, and the Q-factor and the coupling effect may increase.

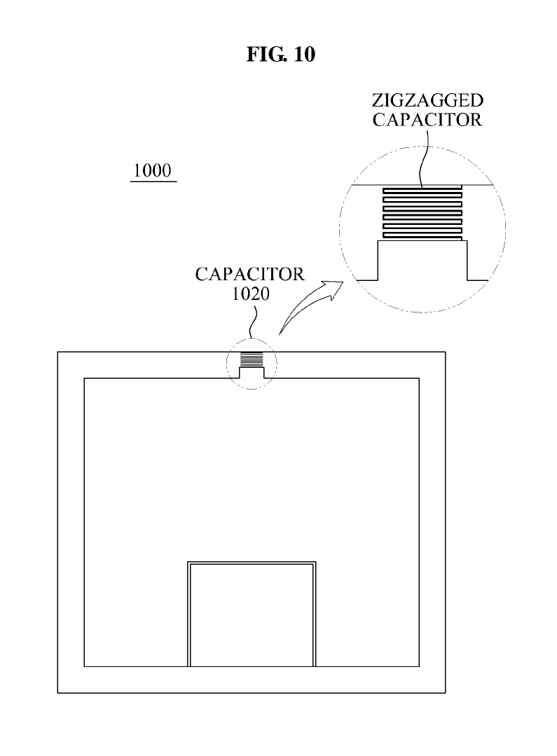

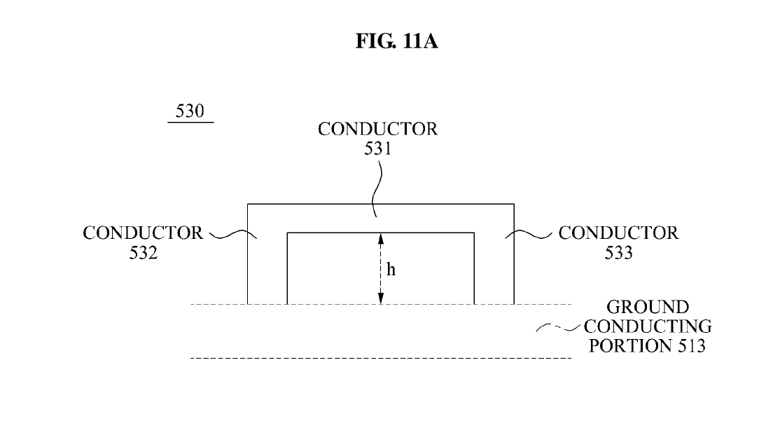

FIG. 10 illustrates an example of a resonator for wireless power transmission that includes a distributed capacitor.

Referring to FIG. 10, a capacitor 1020 included in the resonator 1000 for the wireless power transmission may be a distributed capacitor. A capacitor as a lumped element may have a relatively high equivalent series resistance (ESR). A variety of schemes have been proposed to decrease the ESR contained in the capacitor of the lumped element. For example, by using the capacitor 1020 as a distributed element, it is possible to decrease the ESR. A loss caused by the ESR may decrease a Q-factor and a coupling effect.

As shown in FIG. 10, the capacitor 1020 as the distributed element may have a zigzagged structure. For example, the capacitor 1020 as the distributed element may be configured as a conductive line and a conductor having the zigzagged structure.

As shown in FIG. 10, by employing the capacitor 1020 as the distributed element, it is possible to decrease the loss that occurs due to the ESR. In addition, by disposing a plurality of capacitors as lumped elements, it is possible to decrease the loss that occurs due to the ESR. Because a resistance of each of the capacitors as the lumped elements decreases through a parallel connection, active resistances of parallel-connected capacitors as the lumped elements may also decrease and the loss that occurs due to the ESR may decrease. For example, by employing ten capacitors of 1 pF instead of using a single capacitor of 10 pF, it is possible to decrease the loss occurring due to the ESR.

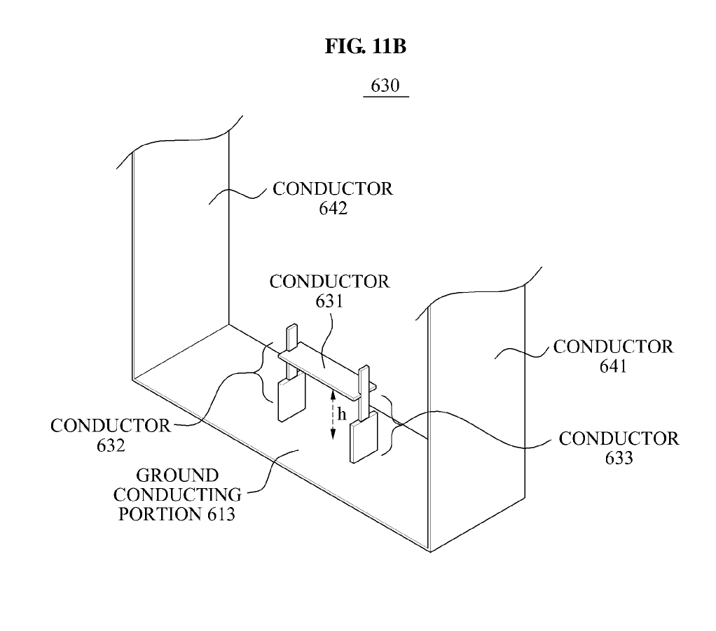

FIG. 11A illustrates an example of the matcher 530 used in the resonator 500 of FIG. 5, and FIG. 11B illustrates an example of the matcher 630 used in the resonator 600 of FIG. 6.

FIG. 11A illustrates a portion of the 2D resonator example including the matcher 530, and FIG. 11B illustrates a portion of the 3D resonator example including the matcher 630.

Referring to FIG. 11A, the matcher 530 includes a conductor 531, a conductor 532, and a conductor 533. The conductors 532 and 533 may be connected to the ground conducting portion 513 and the conductor 531. The impedance of the 2D resonator may be determined based on a distance h between the conductor 531 and the ground conducting portion 513. For example, the distance h between the conductor 531 and the ground conducting portion 513 may be controlled by the controller. The distance h between the conductor 531 and the ground conducting portion 513 may be adjusted using a variety of schemes. For example, the variety of schemes may include a scheme of adjusting the distance h by adaptively activating one of the conductors 531, 532, and 533, a scheme of adjusting the physical location of the conductor 531 up and down, and the like.

Referring to FIG. 11B, the matcher 630 includes a conductor 631, a conductor 632, and a conductor 633. The conductors 632 and 633 may be connected to the ground conducting portion 613 and the conductor 631. The conductors 632 and 633 may be connected to the ground conducting portion 613 and the conductor 631. The impedance of the 3D resonator may be determined based on a distance h between the conductor 631 and the ground conducting portion 613. For example, the distance h between the conductor 631 and the ground conducting portion 613 may be controlled by the controller. Similar to the matcher 530 included in the 2D resonator example, in the matcher 630 included in the 3D resonator example, the distance h between the conductor 631 and the ground conducting portion 613 may be adjusted using a variety of schemes. For example, the variety of schemes may include a scheme of adjusting the distance h by adaptively activating one of the conductors 631, 632, and 633, a scheme of adjusting the physical location of the conductor 631 up and down, and the like.

Although not illustrated in FIGS. 11A and 11B, the matcher may include an active element. A scheme of adjusting an impedance of a resonator using the active element may be similar as described above. For example, the impedance of the resonator may be adjusted by changing a path of current flowing through the matcher using the active element.

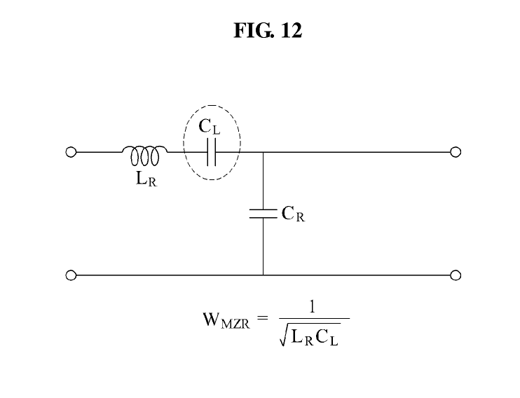

FIG. 12 illustrates an example of an equivalent circuit of the resonator 500 for wireless power transmission of FIG. 5.

The resonator 500 for the wireless power transmission may be modeled to the equivalent circuit of FIG. 12. In the equivalent circuit of FIG. 12, C_{L} corresponds to a capacitor that is inserted in a form of a lumped element in the middle of the transmission line of FIG. 5.

In this example, the resonator 500 may have a zeroth resonance characteristic. For example, when a propagation constant is “0”, the resonator 500 may be assumed to have ω_{MZR} as a resonance frequency. The resonance frequency ω_{MZR} may be expressed by Equation 2.

$${ω}_{MZR} = \frac{1}{\sqrt{{L}_{R} {C}_{L}}} \qquad [ Equation 2 ]$$

In Equation 2, MZR corresponds to a Mu zero resonator.

Referring to Equation 2, the resonance frequency ω_{MZR} of the resonator 500 may be determined by L_{R}/C_{L}. A physical size of the resonator 500 and the resonance frequency ω_{MZR} be independent with respect to each other. Because the physical sizes are independent with respect to each other, the physical size of the resonator 500 may be sufficiently reduced.

The examples described herein relate to a device that may receive power wirelessly from a source. The device may include a resonator for receiving wireless power and a battery that uses the received wireless power to charge a power source. The device may also include one or more circuit boards that are configured to perform operations of the device.

When the resonator is receiving power wirelessly, and the battery is charging the power source at the same time, the received wireless power may disrupt the performance of the battery as it charges the power source. The disruption may be caused by an eddy current or the magnetic field of an eddy current. Also, when the device comprises one or more circuit boards, the eddy current may disrupt the performance the circuit boards.

Accordingly, examples herein describe that a film may be inserted into the device, such that the film protects the resonator from the battery and/or the one or more circuit boards. By shielding the resonator from the battery and the one or more circuit boards, the eddy effect of the eddy current may be reduced and/or minimized.

The processes, functions, methods, and/or software described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A wireless power receiving apparatus comprising:
a resonator to receive wireless power;
a battery to charge a power source using the wireless power received by the resonator; and
a film to shield against a magnetic field caused by an eddy current that occurs while the power source is charged.

2. The wireless power receiving apparatus of claim 1, wherein the film is disposed between the resonator and the battery, and a size of the film is greater than a size of the battery.

3. The wireless power receiving apparatus of claim 1, wherein the film is disposed between the resonator and the battery to contact with a rear cover of a device, and a size of the film is greater than a size of the battery.

4. The wireless power receiving apparatus of claim 1, wherein the film is disposed between the resonator and the battery to cover an entire area except for an area receiving the magnetic field of the resonator, and a size of the film is greater than a size of the battery.

5. The wireless power receiving apparatus of claim 1, wherein, when a resonance frequency of the resonator is changed by the film, the changed resonance frequency is corrected by adjusting at least one of a capacitance of a capacitor and an inductance of an inductor, of the resonator.

6. The wireless power receiving apparatus of claim 1, wherein the resonator is a three-dimensional (3D) type resonator that has thin film resonators disposed in parallel.

7. The wireless power receiving apparatus of claim 1, further comprising a plurality of circuit boards that are configured to perform operations of a device,
wherein the film is disposed between the resonator and the plurality of circuit boards.

8. A device comprising:
a resonator configured to receive power wirelessly from a source;
a battery configured to charge a power source using the wireless power received by the resonator;
a plurality of circuits boards configured to perform operations of the device; and
a film configured to reduce the impact of an eddy current of the resonator on the battery and the plurality of circuit boards,
wherein the film is disposed on a top surface of the resonator, and the battery and the plurality of circuit boards are disposed on a top surface of the film.

9. The device of claim 8, further comprising a housing that houses the plurality of circuit boards and the battery.

10. The device of claim 8, wherein the film has a size that is greater than the size of battery and the plurality of circuit boards

11. The device of claim 8, wherein, when the resonance frequency of the resonator is changed due to the film, the resonator is configured to be adjusted to correct the changed resonance frequency by adjusting at least one of a capacitance of a capacitor and an inductance of an inductor, of the resonator.

12. The device of claim 8, wherein the resonator comprises a plurality of thin film resonators disposed in parallel to each other, and each is configured to receive power wirelessly from the source.

13. The device of claim 8, wherein the film is configured to reduce the impact of the eddy current which occurs when the battery is charging the power source, the plurality of circuit boards are in operation, and the resonator is receiving power wirelessly.
